(19) United States
(12) Patent Application Publication
(10) Pub. No.: US 2021/0197277 A1
(43) Pub. Date: Jul. 1, 2021

(54) MN-CU-Based Damping Alloy Powder For Use In Selective Laser Melting Process And Preparation Method Thereof

(71) Applicant: Central Iron & Steel Research Institute, Beijing (CN)

(72) Inventors: Changjun Wang, Beijing (CN); Yongqing Sun, Beijing (CN); Zhenbao Liu, Beijing (CN); Jianxiong Liang, Beijing (CN); Zhiyong Yang, Beijing (CN); Jie Su, Beijing (CN); Chunxu Wang, Beijing (CN); Wenhui LI, Beijing (CN); Conghui Ma, Beijing (CN); Jiaqi Hu, Beijing (CN); Yong Li, Beijing (CN); Shun Han, Beijing (CN); Jing Ning, Beijing (CN); Qi Gao, Beijing (CN)

(21) Appl. No.: 17/136,085

(22) Filed: Dec. 29, 2020

(30) Foreign Application Priority Data
Dec. 30, 2019 (CN) 201911399302.X

(51) Int. Cl. B22F 10/28; C22B 9/04; B22F 9/08; B33Y 10/00; B33Y 40/10; B33Y 70/00; B33Y 40/20; B22F 10/36; B22F 10/34; B22F 10/66

(52) U.S. Cl. CPC B22F 10/28; C22B 9/04; B22F 9/082; B33Y 10/00; B33Y 40/10; B33Y 80/00; B33Y 40/20; B22F 10/36; B22F 10/34; B22F 10/66; B33Y 70/00

(57) ABSTRACT

The present invention belongs to the technical field of metal materials for additive manufacturing, and relates to a Mn—Cu-based damping alloy powder for use in a selective laser melting (SLM) process and a preparation method thereof. The powder has chemical components in percent by weight as follows: C: ≤0.15%, Ni: 4.9-5.2%, Si: ≤0.15%, Fe: 1.8-5.0%, Cu: 20-23%, P: ≤0.03%, S: ≤0.06%, and the balance being Mn and inevitable impurities. The preparation method includes: preparation of master alloy, powdering by vacuum induction melting gas atomization (VIGA), mechanical vibrating and air classification screening under protection of an inert gas and collecting. Compared with the prior art, the powder of the present invention has a high sphericity, a high apparent density, a small angle of repose, a desired fluidity and a relatively high yield of fine powders having a size of 15-53 μm.

### TECHNICAL FIELD

The present invention belongs to the technical field of metal materials for additive manufacturing, and specifically relates to a Mn—Cu-based damping alloy powder for use in a selective laser melting (SLM) process and a preparation method thereof.

### BACKGROUND

With development of science and technology and improvement of living standards, how to reduce vibration and noise has attracted increasing attentions from individuals and enterprises. Especially with development of equipment with increasing speed and power in aerospace, ship and automotive fields, a resulted broadband random excitation causes responsive multiple resonance humps of a structure, which results in failure of electronic devices and instruments and even a serious disaster. In order to solve the problems with vibration and noise, damping elements are made of materials with high damping properties with respect to specific sources of vibration and noise, to convert vibration energy into heat energy, thereby achieving reduction of vibration and noise. Therefore, researches and applications of high vibration damping alloy materials not only have academic significance but also have broad market application prospects.

Metal-based damping alloys, as novel functional structural materials, can achieve integration of a vibration source, namely a load-bearing component, and a damping component. Compared with a traditional strategy in reducing vibration and noise, the metal-based damping alloys have advantages such as simple processes, a low cost, a wide application range, an advanced technology, and a desired effect, and have been applied in many fields. Compared with other damping alloys, a typical twin type damping Mn—Cu-based alloy has a wide range of applications in aerospace, ship, and precision electronic instrument fields due to its excellent damping performance and relatively desired mechanical properties. However, due to the moderate hot workability, most of the Mn—Cu-based alloys are formed by casting or complex precision forging. Comparatively, additive manufacturing (3D printing) has technical advantages such as not being restricted by complexity of a part, a high material utilization rate and a short manufacturing cycle, and is one of the most promising manufacturing technologies in the future. For additive manufacturing, SLM technology requires a relatively small range of particle size of metal powders (15-53 μm), thus gas atomization is mainly used to obtain the powders domestic and abroad. A vacuum induction melting gas atomization (VIGA) method is the only method that can efficiently prepare metal powders for SLM technology in large quantities with a low cost. Atomized powder prepared thereby has advantages such as a high sphericity, a controllable powder particle size, a low oxygen content and adaptability to production of a variety of metal powders. The VIGA method has become a main direction for development of preparation technology of alloy powders with high performance and special alloy powders.

### SUMMARY

An objective of the present invention is to provide a Mn—Cu-based damping alloy powder for use in an SLM process and a preparation method thereof. Through design of alloy composition, a powdering process, a matching 3D printing process and a post-processing treatment, a Mn—Cu-based damping alloy powder suitable for additive manufacturing (SLM) process is obtained. Thus, the present invention provides another method of manufacturing damping Mn—Cu-based alloy parts in addition to the casting and the precision forging, and metal powder consumables.

The Mn—Cu-based powder of the present invention has chemical components in percent by weight as follows: C: ≤0.15%, Ni: 4.9-5.2%, Si: ≤0.15%, Fe: 1.8-5.0%, Cu: 20-23%, P: ≤0.03%, S: ≤0.06%, and the balance being Mn and inevitable impurities. Various elements in the present invention have functions and contents as follows:

C: as an atom for forming an interstitial solution treatment, C can increase strength of an alloy matrix, but it can damage plasticity and toughness of steel and printing compactibility with an SLM process. C can expand the γ phase area, but cannot have an infinite solid solubility, and formation of carbides with a matrix element is detrimental to performance of the Mn—Cu-based alloy. Therefore, a content of the C in the Mn—Cu-based alloy of the present invention is controlled within 0.15%.

Ni: a damping Mn—Cu-based alloy has poor corrosion resistance due to a high content of Mn. Therefore, the content of Mn is reduced by adding Ni and other alloying elements to improve the mechanical properties of the material, the casting process and the corrosion resistance to meet requirements of use. It is generally believed that the Ni in a solution treatment will stabilize the γ phase, leading to slow formation of a zone rich in Mn, but the Ni is disadvantageous for the damping performance. Therefore, the Ni in the Mn—Cu-based alloy of the present invention is controlled within 4.9-5.2%.

Si: Si is a harmful element in the Mn—Cu-based alloys, which will form oxide inclusions and has a relatively great impact on mechanical properties. A content of the Si in the Mn—Cu-based alloy of the present invention is controlled within 0.15%.

Fe: the Fe element can act as a nucleus for stress induced martensite and promote formation of a large amount of γ martensites in the alloy. At the same time, Fe can also promote spinodal decomposition of a Mn-based alloy, produce a zone rich in Mn or poor in Mn, promote precipitation on grain boundaries, and improve the damping performance of the alloy. After a comprehensive consideration, a content of the Fe in the Mn—Cu-based alloy of the present invention is controlled within 1.8-5.0%.

Cu: Cu as a matrix element can significantly improve the damping performance and hot and cold working performance of the Mn—Cu-based alloy. The mechanism lies in that a crystal structure of Cu changes with temperature in a solution treatment, resulting in a large number of crystal interfaces, and during an interface movement, a lot of vibration energy will be absorbed. After a comprehensive consideration, a content of the Cu in the Mn—Cu-based alloy of the present invention is controlled within 20-23%.

P and S: as impurities in steel, P and S significantly reduce plasticity and toughness of an alloy and printing compactibility with an SLM process. Since the present invention uses a vacuum induction melting (VIM) process to treat a master alloy, a content of the P or S can be controlled within 0.03% or 0.06% respectively.

Mn: as a matrix element, Mn has a significant influence on the damping performance. It is found through researches that when the Mn content is about 60-70%, the alloy has the highest damping performance. Further increase of the Mn content results in decrease in fluidity of the alloy liquid, thereby affecting the outcome of atomized powders. At the same time, corrosion resistance and strength of the alloy also decrease with the increase of the Mn content. After a comprehensive consideration, a content of the Mn in the Mn—Cu-based alloy of the present invention is controlled at 60-70%.

The present invention can efficiently prepare Mn—Cu-based damping alloy powders for printing with SLM which meet requirements, have a controllable particle size, a high sphericity, a low manufacturing cost and a high metal powder yield, and are suitable for industrial production.

The Mn—Cu-based alloy powder and the preparation method thereof involved in the present invention are as follows:

Step (1): preparation of master alloy: preparing a master alloy with VIM, where components of the master alloy are as follows: C: ≤0.15%, Ni: 4.9-5.2%, Si: ≤0.15%, Fe: 1.8-5.0%, Cu: 20-23%, P: ≤0.03%, S: ≤0.06%, and the balance being Mn and inevitable impurities.

Step (2): powdering by VIGA: putting the master alloy into a melting pot, vacuumizing a melting chamber to a pressure below 0.1 Pa, filling with argon with a purity of 99.999% or more until the pressure in the melting chamber returns to a standard atmospheric pressure, induction heating the master alloy to 1,300-1,500° C. for complete melting, pouring a molten metal liquid into a MgO tundish, performing supersonic atomization with argon having a purity of 99.999% as a medium at a pressure of 6.0-8.0 MPa to obtain powders, cooling atomized metal powders in a cooling chamber and directly collecting the metal powders in a sealed container under a cyclone separator.

Step (3): powder screening and collection: subjecting the metal powders in a powder collecting tank to mechanical vibration and air classification screening under protection of an inert gas, vacuum sealing and packing screened metal powders having a particle size of 15-53 μm for use in an SLM technology.

Step (4): SLM-based preparation of standard parts: putting invented Mn—Cu-based damping alloy powders having a particle size of 15-53 μm into SLM laser additive manufacturing equipment, preparing standard parts with mechanical properties where laser printing is carried out with a spot diameter of 70-100 μm, a laser power of 200-280 W, a scanning speed of 900-1,100 mm/s, a pass distance of 100-150 μm and a single layer spreading thickness of 20-30 μm, and the printing can allow a part to have a density of more than 99.5%.

Step (5): heat treating of standard parts: subjecting additive manufactured standard parts to heat isostatic pressing+solution treatment+aging treatments, where The heat isostatic pressing is carried out at 800-950° C. at ≥100 MPa for 2-4 h with subsequence cooling to room temperature in a furnace; the solution treatment is carried out at 880-920° C. for 2-4 h with subsequent water cooling to room temperature; the aging is carried out at 400-450° C. for 3-6 h with subsequent air cooling to room temperature.

Compared with the prior art, the present invention has the following advantages:

(1) Based on combination of a novel alloy system design and a powdering process, the Mn—Cu-based damping alloy powder of the present invention has a high sphericity (>90%), a high apparent density (>3.8 g/cm³), a small angle of repose)(<34°, a desired fluidity and a relatively high yield of fine powders having a size of 15-53 μm, which are critical to excellent comprehensive mechanical properties and damping performance of later 3D printed standard parts.

(2) Based on physical characteristics of the invented Mn—Cu-based damping alloy powder, corresponding SLM laser printing parameters and a post-processing system are proposed, so that the final 3D printed standard parts can have extremely excellent comprehensive mechanical properties and damping performance with a tensile strength >560 MPa at room temperature, a yield strength >300 MPa, an elongation rate of more than 20% and a damping performance Q⁻¹ of above 0.028 at room temperature.

The Mn—Cu-based damping alloy powder of the present invention can be applied to vibration damping parts for additive manufacturing in aerospace and ship fields, and can also be extended to additive manufacturing of precision electronic instruments in transportation and nuclear power fields, which has a promising prospect on markets.

### BRIEF DESCRIPTION OF DRAWINGS

FIG. 1 shows particle size distribution of the metal powders in Example 1.

FIG. 2 shows the macromorphology of the metal powders in Example 2.

FIG. 3 shows the morphology of internal structure of the metal powder in Example 3.

FIG. 4 shows the relationship between temperature and damping performance of the printed piece of Example 1 after HIP850 and HIP920 heat treatments.

FIG. 5 shows the metallographic structure of the printed part of Example 2 after heat treatment (HIP850).

FIG. 6 shows the metallographic structure of the printed part of Example 2 after heat treatment (HIP920).

FIG. 7 shows a graph of the morphology of the transmission (transmission electron microscope (TEM)) structure of the printed part of Example 3 after treatment with the HIP850 system.

FIG. 8 shows another graph of the morphology of the transmission (TEM) structure of the printed part of Example 3 after treatment with the HIP850 system.

### DETAILED DESCRIPTION

### Example 1

Step (1): preparation of master alloy: a master alloy was prepared with a VIM furnace, where components of the master alloy were as follows: C: 0.05%, Ni: 5.19%, Si: 0.05%, P: 0.008%, S: 0.016%, Fe: 4.13%, Cu: 20.4%, and the balance being Mn and inevitable impurities.

Step (2): powdering by VIGA: the master alloy was put into a melting pot. A melting chamber was vacuumized to a pressure below 0.1 Pa, and filled with argon with a purity of 99.999% or more until the pressure in the melting chamber returned to a standard atmospheric pressure. The master alloy was induction heated to 1,400° C. for complete melting. Then a molten metal liquid was poured into a MgO tundish. Supersonic atomization was performed with argon having a purity of 99.999% as a medium at a pressure of 6.5 MPa to obtain powders. Atomized metal powders were cooled in a cooling chamber and directly collected in a sealed container under a cyclone separator. The metal powders in a powder collecting tank were subjected to mechanical vibration and air classification screening under protection of an inert gas. Metal powders having a particle size of 15-53 μm for use in an SLM technology were sealed by vaccumization and packed.

Step (3): SLM-based preparation of standard parts: invented Mn—Cu-based damping alloy powders having a particle size of 15-53 μm were put into SLM laser additive manufacturing equipment. Standard parts with mechanical properties were prepared where laser printing was carried out with a spot diameter of 80 μm, a laser power of 250 W, a scanning speed of 1,000 mm/s, a pass distance of 150 μm and a single layer spreading thickness of 30 μm.

### Example 2

Step (1): preparation of master alloy: a master alloy was prepared with a VIM furnace, where components of the master alloy were as follows: C: 0.028%, Ni: 4.93%, Si: 0.03%, P: 0.007%, S: 0.058%, Fe: 2.18%, Cu: 22.5%, and the balance being Mn and inevitable impurities.

Step (2): powdering by VIGA: the master alloy was put into a melting pot. A melting chamber was vacuumized to a pressure below 0.1 Pa, and filled with argon with a purity of 99.999% or more until the pressure in the melting chamber returned to a standard atmospheric pressure. The master alloy was induction heated to 1,450° C. for complete melting. Then a molten metal liquid was poured into a MgO tundish. Supersonic atomization was performed with argon having a purity of 99.999% as a medium at a pressure of 7.0 MPa to obtain powders. Atomized metal powders were cooled in a cooling chamber and directly collected in a sealed container under a cyclone separator. The metal powders in a powder collecting tank were subjected to mechanical vibration and air classification screening under protection of an inert gas. Metal powders having a particle size of 15-53 μm for use in an SLM technology were sealed by vaccumization and packed.

Step (3): SLM-based preparation of standard parts: invented Mn—Cu-based damping alloy powders having a particle size of 15-53 μm were put into SLM laser additive manufacturing equipment. Standard parts with mechanical properties were prepared where laser printing was carried out with a spot diameter of 80 μm, a laser power of 230 W, a scanning speed of 950 mm/s, a pass distance of 120 μm and a single layer spreading thickness of 30 μm.

### Example 3

Step (1): preparation of master alloy: a master alloy was prepared with a VIM furnace, where components of the master alloy were as follows: C: 0.11%, Ni: 5.14%, Si: 0.06%, P: 0.018%, S: 0.037%, Fe: 4.86%, Cu: 22.4%, and the balance being Mn and inevitable impurities.

Step (2): powdering by VIGA: the master alloy was put into a melting pot. A melting chamber was vacuumized to a pressure below 0.1 Pa, and filled with argon with a purity of 99.999% or more until the pressure in the melting chamber returned to a standard atmospheric pressure. The master alloy was induction heated to 1,480° C. for complete melting. Then a molten metal liquid was poured into a MgO tundish. Supersonic atomization was performed with argon having a purity of 99.999% as a medium at a pressure of 7.5 MPa to obtain powders. Atomized metal powders were cooled in a cooling chamber and directly collected in a sealed container under a cyclone separator. The metal powders in a powder collecting tank were subjected to mechanical vibration and air classification screening under protection of an inert gas. Metal powders having a particle size of 15-53 μm for use in an SLM technology were sealed by vaccumization and packed.

Step (3): SLM-based preparation of standard parts: invented Mn—Cu-based damping alloy powders having a particle size of 15-53 μm were put into SLM laser additive manufacturing equipment. Standard parts with mechanical properties were prepared where laser printing was carried out with a spot diameter of 80 μm, a laser power of 260 W, a scanning speed of 1,100 mm/s, a pass distance of 150 μm and a single layer spreading thickness of 25 μm.

Table 1 and Table 2 respectively showed the alloy components, particle size distribution intervals and yields of fine powders having a particle size of 15-53 μm of the metal powders in Examples 1-3. It can be seen that, the Mn—Cu-based powders prepared by the VIGA method of the present invention had a relatively large content of fine powders with a high yield of fine powders in a corresponding range of 15-53 μm, which was very suitable for industrial production and promotion of application. Table 3 showed the physical property test results of the metal powders of Examples 1-3. It can be seen that the Mn—Cu-based damping alloy powders of the present invention had a high apparent density (>3.8 g/cm³), a small angle of repose (<34°) and a desired fluidity index (>85%), showing extremely excellent comprehensive performances. These properties were critical to excellent comprehensive mechanical properties and damping performance of later 3D printed standard parts.

Table 4 showed the test results of the mechanical properties and the damping performance of the metal powders prepared in Examples 1-3 after SLM printing and corresponding heat treatments. All the examples were implemented with two post-processing treatments, namely an HIP850 system: 850° C./3 h (pressure of 120 MPa) with cooling in a furnace+880° C./2 h with water cooling+425° C./4 h with air cooling; and an HIP920 system: 920° C./3 h (pressure of 120 MPa) with cooling in a furnace+900° C./2 h with water cooling+425° C./4 h with air cooling. It can be seen that, after the two heat treatment systems, the examples had extremely excellent mechanical properties matching the damping performance with the tensile strength >560 MPa at room temperature, the yield strength >300 MPa, the elongation rate of more than 20% and the damping performance Q⁻¹ of above 0.028 at room temperature.

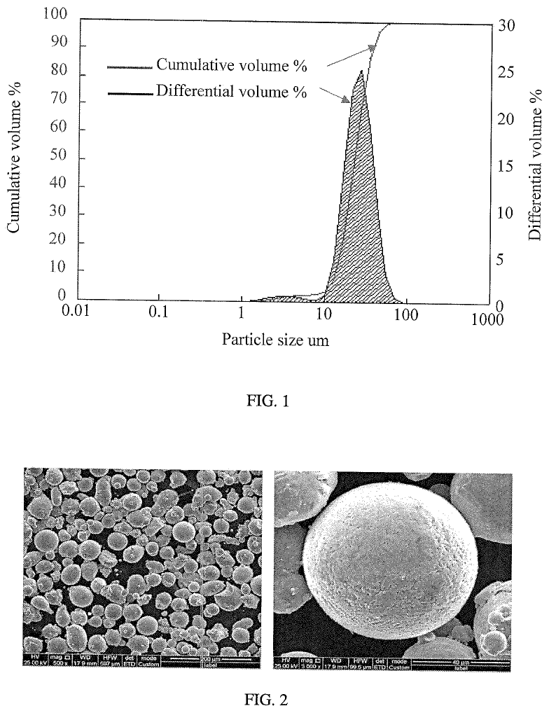

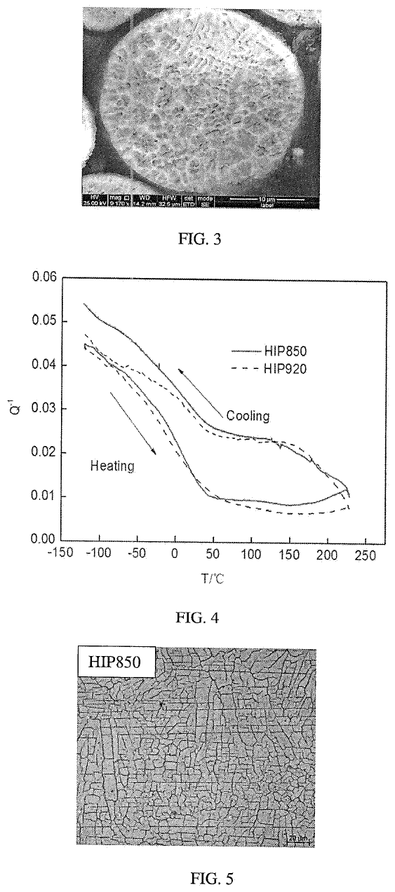

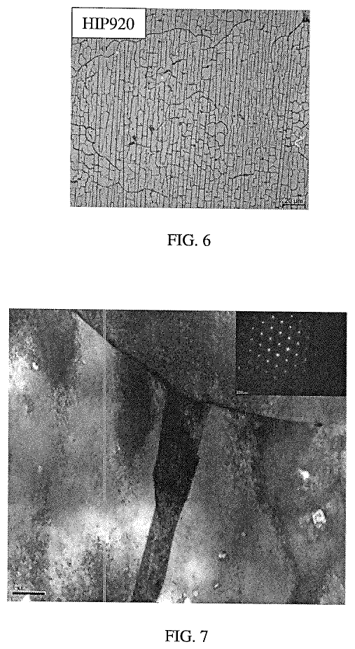

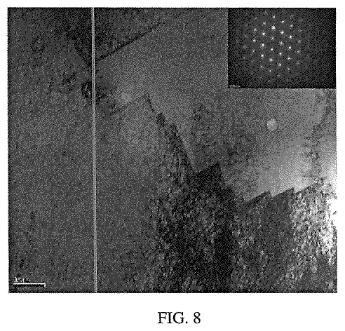

FIG. 1 showed particle size distribution of the metal powders in Example 1. The macromorphology of the metal powders in Example 2 was characterized with an TEM and shown in FIG. 2. It can be seen that, the Mn—Cu-based damping alloy powders developed by the present invention had high surface smoothness and desired sphericity. FIG. 3 showed the morphology of the internal structure of the metal powder in Example 3. It can be seen that, the powder had internal solidification structures mainly in forms of a columnar crystal+an equiaxed crystal, and internal crossed phase interfaces. FIG. 4 showed the relationship between temperature and damping performance of the printed part of Example 1 after HIP850 and HIP920 heat treatments. It can be seen that, the powders developed by the present invention had excellent damping performance after printing and heat treatments. FIGS. 5 and 6 showed the metallographic structures of the printed part of Example 2 after HIP850 and HIP920 treatment respectively. It can be seen that, there was a large number of twin microstructures in the martensite matrix structure, and this was the most important reason why the present invention had excellent damping performance and mechanical properties. FIGS. 7-8 showed graphs of the morphology of the transmission (TEM) structure of the printed part of Example 3 after treatment with the HIP850 system.

The above merely describes some preferred examples of the present invention, and the protection scope of the present invention is not limited to the above specific embodiments. The above specific embodiments are illustrative and not restrictive. Where the materials and methods of the present invention are used, all specific extensions without departing from the purpose of the present invention and the protection scope of the claims should fall within the protection scope of the present invention.

TABLE 1
Alloy components of the metal powders in the examples (wt. %)

| Example | C | Si | P | S | Ni | Cu | Fe | Mn |
|---|---|---|---|---|---|---|---|---|
| Example 1 | 0.021 | 0.042 | <0.005 | 0.012 | 5.14 | 20.17 | 3.85 | 70 |
| Example 2 | 0.014 | 0.018 | <0.005 | 0.058 | 4.78 | 22.71 | 1.96 | 65.11 |
| Example 3 | 0.074 | 0.043 | 0.016 | 0.03 | 5.1 | 22.62 | 4.46 | 66.1 |

TABLE 2
Particle size distribution and yield of fine powders having a
particle size of 15-53 μm in the examples

| | D10 | D50 | D90 | 15-53 pm fine powders |
|---|---|---|---|---|
| Example | (μm %) | (μm) | (μm) | Yield (%) |
| Example 1 | 17.7 | 28.82 | 46.45 | 29.2 |
| Example 2 | 18.2 | 28.99 | 52.1 | 28.6 |
| Example 3 | 13.3 | 29.65 | 48.01 | 31.4 |

TABLE 3
Test results of physical properties in the examples

| | Apparent | Tap | | | Degree of |
|---|---|---|---|---|---|
| | density | density | Angle of | Fluidity | compression |
| Example | (g/cm³) | (g/cm³) | repose (°) | index | % |
| Example 1 | 3.81 | 4.41 | 29.42 | 87.5 | 13.15 |
| Example 2 | 3.88 | 4.53 | 33.06 | 85 | 14.35 |
| Example 3 | 3.82 | 4.31 | 31.31 | 90 | 11.37 |

TABLE 4
Mechanical properties and damping performance of the metal
powders in examples after heat treatments

| | Tensile | Yield | | Damping |
|---|---|---|---|---|
| | strength, | strength, | Elongation | performance Q⁻¹ |
| | MPa | MPa | rate, % | at room temperature |
| Example 1 | | | | |
| HIP850 | 641 | 388 | 20.5 | 0.030 |
| HIP920 | 602 | 318 | 30.5 | 0.029 |
| Example 2 | | | | |
| HIP850 | 625 | 375 | 21.5 | 0.031 |
| HIP920 | 578 | 308 | 34.5 | 0.028 |
| Example 3 | | | | |
| HIP850 | 628 | 380 | 22.0 | 0.029 |
| HIP920 | 580 | 311 | 31.5 | 0.029 |

What is claimed is:

1. A Mn—Cu-based damping alloy powder for use in a selective laser melting (SLM) process, comprising chemical components in percent by weight as follows: C: ≤0.15%, Ni: 4.9-5.2%, Si: ≤0.15%, Fe: 1.8-5.0%, Cu: 20-23%, P: ≤0.03%, S: ≤0.06%, and the balance being Mn and inevitable impurities.

2. A 3D printed manufactured part comprising:
an alloy comprising chemical components in percent by weight as follows: C: ≤0.15%, Ni: 4.9-5.2%, Si: ≤0.15%, Fe: 1.8-5.0%, Cu: 20-23%, P: ≤0.03%, S: ≤0.06%, and the balance being Mn and inevitable impurities, wherein based on the above components in percent by weight, the 3D printed manufactured part obtained after selective laser melting (SLM) additive manufacturing and heat treatment has a tensile strength >560 MPa at room temperature, a yield strength >300 MPa, an elongation rate of more than 20% and a damping performance Q⁻¹ of above 0.028 at room temperature.

3. A method of preparing the Mn—Cu-based damping alloy powder for use in an SLM process according to claim 1, comprising the steps of:
preparing a master alloy with vacuum induction melting (VIM), wherein components of the master alloy are as follows: C: ≤0.15%, Ni: 4.9-5.2%, Si: ≤0.15%, Fe: 1.8-5.0%, Cu: 20-23%, P: ≤0.03%, S: ≤0.06%, and the balance being Mn and inevitable impurities;
putting the master alloy into a melting pot, vacuumizing a melting chamber to a pressure below 0.1 Pa, filling with argon with a purity of 99.999% or more until the pressure in the melting chamber returns to a standard atmospheric pressure, induction heating the master alloy to 1,300-1,500° C. for complete melting, pouring a molten metal liquid into a MgO tundish, performing supersonic atomization with argon having a purity of 99.999% as a medium at a pressure of 6.0-8.0 MPa to obtain powders, cooling atomized metal powders in a cooling chamber and directly collecting the metal powders in a sealed container under a cyclone separator;
subjecting the metal powders in a powder collecting tank to mechanical vibration and air classification screening under protection of an inert gas, vacuum sealing and packing screened metal powders having a particle size of 15-53 μm for use in an SLM technology;
putting said Mn—Cu-based damping alloy powders having a particle size of 15-53 μm into SLM laser additive manufacturing equipment, preparing standard parts with mechanical properties wherein laser printing is carried out with a spot diameter of 70-100 μm, a laser power of 200-280 W, a scanning speed of 900-1,100 mm/s, a pass distance of 100-150 μm and a single layer spreading thickness of 20-30 μm, and the printing allows a part to have a density of more than 99.5%;
subjecting additive manufactured standard parts to heat isostatic pressing+solution treatment+aging treatments, wherein the heat isostatic pressing is carried out at 800-950° C. for 2-4 h at ≥100 MPa; the solution treatment is carried out at 880-920° C. for 2-4 h with subsequent water cooling to room temperature; the aging is carried out at 400-450° C. for 3-6 h with subsequent air cooling to room temperature.
